(19) United States
(12) Patent Application Publication
(10) Pub. No.: US 2002/0008059 A1
(43) Pub. Date: Jan. 24, 2002

(54) Grease filter remover

(76) Inventor: Ronald J. Krebel, Waterloo, IL (US)

Correspondence Address: Ronald J. Krebel, 6905 Deer Hill Rd., Waterloo, IL, 62298, US

(21) Appl. No.: 09/775,520

(22) Filed: Feb. 5, 2001

Related U.S. Application Data
(60) Provisional application No. 60/183,964, filed on Feb. 22, 2000.

(51) Int. Cl. B01D 24/00

(52) U.S. Cl. 210/348

(57) ABSTRACT

The grease filter remover is a device that by working the handle the head pivots moving the stationary fingers. Moving the handle up and out will pivot top of head inward moving lower fingers out and top fingers in. Moving handle down and inward will pivot bottom of head inward moving lower finger inward and top of finger outward.

### BACKGROUND OF INVENTION

The Grease filter is used in commercial kitchens and restaurants. They are located above the cooking area, slanted with the top of the filter leaning toward the front of the cooking surface. A grease filter is made of stainless steel and measures 15½ inch by 24½ inch by 1¾ inch thick and weighs approximately 5 pounds. It's make up provides a ⅝ inch lip surrounding the entire filter panel. The grease filter vary in size and in location but the general make up is the same. The location of the filters makes it difficult to change without the aid of using a ladder, while reaching over the cooking surface to remove. Grease filters have to be regularly cleaned to remove grease and other contaminants from the cooking of food. This device is used to remove and to re-install the grease filter.

The handle is made of ½ inch steel thinwall conduit 60 inches long with a 20 degree or so bend 7 inches from end. It is connected and locked into place on the head of the device by use of a ½ inch conduit connecter welded into place in the center of a steel channel 1 inch wide 1/16 inch thick 8 inches long.(The head). Two metal rods 9½ inches long 3/16 inch steel round stock with a 90 degree bend ½ inch from end are welded into place perpendicular to channel, 6¼ inches apart center to center, ⅞ inch from each end. The top of each finger is 3 inches long from channel. The bottom of each finger having the 90 degree bend ½ inch from end pointing to the left.

To remove filter from ceiling insert top finger in lip at top center of filter, lift up then with lower fingers resting between panels of filter slide device to the left inserting 90 degree fingers behind panels. Then raise handle up and outward to move bottom of filter from bottom of filter holder and remove from channel. The head being a fulcrum which moves lower fingers out, moving filter out of filter holder.

To install filter back in holder insert top of fingers into top center of filter, with lower fingers inserted behind panels raise and insert filter into top holder, lower handle to bring bottom edge of filter in lower filter holder. Slide device to the right and remove filter remover.

### BRIEF SUMMARY OF INVENTION

My invention “The Grease Filter Remover” will help in the removal of grease filter without standing on ladder and leaning over a cooking surface. This device is design to pickup and hold filter and lift out of filter holding brackets then lowered all by standing on floor. After filter is cleaned, re-install filter. This device will save time to a minimum so filter will be cleaned more often. Using this device will also reduced the chance of being injured.

### BRIEF DESCRIPTION OF THE DRAWING

FIG. 1 Grease Filter Removing device showing head with fingers, 60 inch handle with 20 degree bend or so with plastic handle grip.

FIG. 2 Head of device made of 1 inch wide 1/16 inch. thick, 8 inches long steel terminal strip channel, with a ½ inch handle connector (½ inch conduit connector) welded to center of channel with channel side up.

FIG. 3 Head of device, face side up with fingers 3 inches long from top edge of channel, 6¼ inches apart center to center, ⅞ inch from each end. 90 degree bend ½ inch from end facing to left.

FIG. 4 Head of device face side down showing fingers welded into place with 90 degree bend ½ inch from end facing to right.

FIG. 5 Fingers 9½ inch long made from 3/16 inch steel round stock with a 90 degree bend 12 inch from end.

FIG. 6 Handle made from ½ inch steel thinwall conduit 60 inches long with a 20 degree or so bend 7 inches from end.

FIG. 7 Plastic handle grip to slide over handle end.

FIG. 8 Handle connector enlarged, (to be seen) to be welded in center of channel, with channel side up.

FIG. 9 End view of channel enlarged,(to be seen) channel side up.

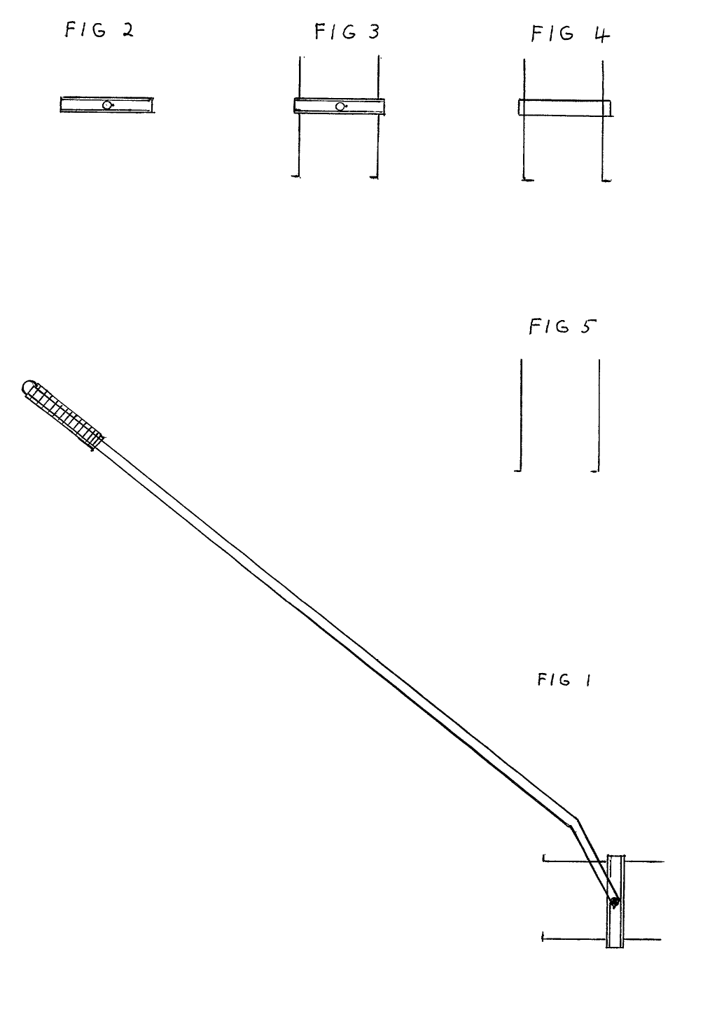

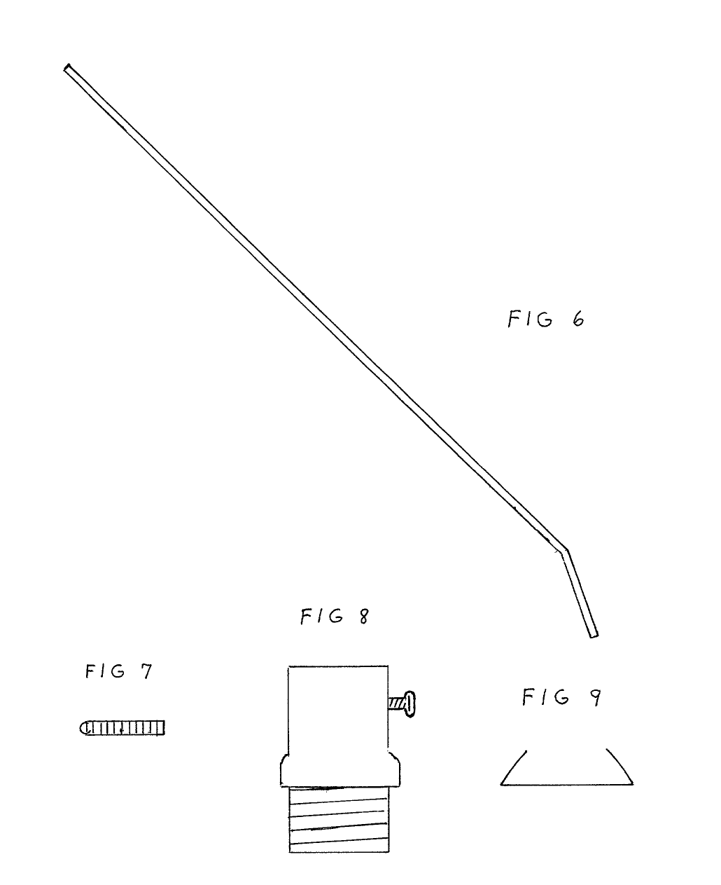

### DETAILED DESCRIPTION OF INVENTION

The head is made from steel terminal strip channel 1″ wide and 8″ long 1/16″ thick with a ½ inch thinwall conduit connector welded in center of channel, with channel side up. The fingers are 9½″ inches long, with one end having a 90 degree bend ½ inch from end. The fingers are welded on channel with channel side down. They are perpendicular to head 6¼″ apart center to center, ⅞″ from each end of channel. The 90 degree bend is facing toward right. The top of the fingers are 3 inches long from top edge of channel with a slight outward bend.

The handle is made of ½ inch thin wall steel conduit 60 inches long with a 20 degree bend or so, 7 inches from end, with a plastic handle grip on opposite end. The handle is inserted into connector locked into place by locking screw on side of connector.

What I claim as my invention is:

1. A grease filter removing device.

2. The head of the device works as a fulcrum, when handle is pivoted.

3. The fingers of the device are stationary which push up when handle is lifted and pull as handle is pivoted up and outward.

4. The 90 degree bend ½ inch from end facing to left.

5. The three inch long fingers from top of head with a slight outward bend.

6. The handle with a 20 degree or so bend 7 inches from end.
